(19) United States
(12) Patent Application Publication
(10) Pub. No.: US 2012/0052818 A1
(43) Pub. Date: Mar. 1, 2012

(54) APPARATUS AND METHOD FOR MANAGING OPERATION MODE OF MOBILE STATION IN WIRELESS COMMUNICATION SYSTEM

(75) Inventors: Byung-Wook Jun, Seoul (KR); Hee-Won Kang, Seongnam-si (KR); Yeong-Moon Son, Yongin-si (KR); Se-Ho Kim, Gwangmyeong-si (KR); Jae-Hyuk Jang, Suwon-si (KR)

(73) Assignee: SAMSUNG ELECTRONICS CO., LTD., Suwon-si (KR)

(21) Appl. No.: 13/216,987

(22) Filed: Aug. 24, 2011

(30) Foreign Application Priority Data
Aug. 24, 2010 (KR) 10-2010-0081770

(51) Int. Cl. H04W 52/02; H04W 4/00

(52) U.S. Cl. 455/68

(57) ABSTRACT

An apparatus and method manage an operation mode of a mobile station in a wireless communication system. Here, a method for managing an operation mode of a Mobile Station (MS) that uses a service of a strict interactive response time in a Base Station (BS) of a wireless communication system includes determining a supportable operation mode of the MS considering at least one of a service type of the MS, an interactive response time required condition of the service, and a user profile of the MS, and sending the MS a control message including the supportable operation mode of the MS.

### CROSS-REFERENCE TO RELATED APPLICATION(S) AND CLAIM OF PRIORITY

The present application is related to and claims priority under 35 U.S.C. §119(a) to a Korean Patent Application filed in the Korean Intellectual Property Office on Aug. 24, 2010 and assigned Serial No. 10-2010-0081770, the contents of which are herein incorporated by reference.

### TECHNICAL FIELD OF THE INVENTION

The present invention relates to a wireless communication system. More particularly, the present invention relates to an apparatus and method for managing an operation mode of a Mobile Station (MS) in a wireless communication system.

### BACKGROUND OF THE INVENTION

In a wireless communication system, an MS can operate in a connected state and an idle state for the sake of reduction of power consumption and efficient management of a wireless resource of a Base Station (BS), after network entry. Here, the connected state includes a sleep mode and an active mode. For instance, in a case where the MS is in the active mode, the MS maintains at least one connection with the BS. At this time, the MS can make a transition to the sleep mode so as to decrease the power consumption.

In a case where the MS operates in the idle state, the MS is not registered to the BS, and operates in a Paging Available Interval (PAI) and a Paging Unavailable Interval (PUI). In this case, the MS monitors paging only in the PAI. Accordingly, in a case where a traffic that the BS will transmit to the MS operating in the idle state is generated, the BS performs paging as illustrated in FIG. 1 below.

FIG. 1 illustrates a procedure for performing paging to an MS that is in an idle state according to the conventional art.

As illustrated in FIG. 1, in a case where an MS 110 operates in an idle state, the MS 110 monitors paging during a PAI. On the other hand, the MS 110 transmits/receives no signal during a PUI.

In a case where a BS 100 recognizes traffic generation for the MS 110, if a PAI of the MS 110 arrives, the BS 100 performs paging (120) to the MS 110. That is, the BS 100 waits during a PUI of the MS 110.

The MS 110 performs a network reentry procedure (130) if paging to itself is detected during a PAI. On the other hand, the MS 110 enters a PUI if no paging to itself is detected during the PAI.

In a case where the MS 110 operates in the idle state as above, the wireless communication system generates a paging delay pending the paging to the MS 110 until before the PAI and a network reentry delay resulting from network reentry of the MS 110.

A service for emergency such as a disaster requires a strict interactive response time of an MS. However, in a case where the MS using the emergency service operates in the idle state, there is a problem that the MS cannot meet the interactive response time required for the emergency service due to the paging delay, the network reentry delay and the like.

### SUMMARY OF THE INVENTION

To address the above-discussed deficiencies of the prior art, it is a primary object to provide at least the advantages below. Accordingly, one aspect of the present disclosure is to provide an apparatus and method for reducing a response delay of a Mobile Station (MS) operating in an idle state in a wireless communication system.

Another aspect of the present disclosure is to provide an apparatus and method for managing an operation mode of an MS in a wireless communication system.

A further aspect of the present disclosure is to provide an apparatus and method for restricting an operation mode of an MS in a Base Station (BS) of a wireless communication system.

Yet another aspect of the present disclosure is to provide an apparatus and method for managing an operation mode to which an MS can make a transition through a negotiation between a BS and the MS in a wireless communication system.

Still another aspect of the present disclosure is to provide an apparatus and method for managing an operation mode to which an MS can make a transition through a Dynamic Service Addition/Change/Deletion (DSx) procedure in a BS of a wireless communication system.

Still another aspect of the present disclosure is to provide an apparatus and method for managing an operation mode to which an MS can make a transition through a registration procedure of the MS in a BS of a wireless communication system.

The above aspects are achieved by providing an apparatus and method for managing an operation mode of a mobile station in a wireless communication system.

According to one aspect of the present disclosure, a method for managing an operation mode of an MS that uses a service of a strict interactive response time in a BS of a wireless communication system is provided. The method includes determining a supportable operation mode of the MS considering at least one of a service type of the MS, an interactive response time required condition of the service, and a user profile of the MS, and sending the MS a control message including the supportable operation mode of the MS.

According to another aspect of the present disclosure, a method for controlling an operation mode in an MS of a wireless communication system is provided. The method includes determining, from a control message provided from the BS, a supportable operation mode of the MS determined from considering at least one of a service type of the MS, an interactive response time required condition of a service, and a user profile of the MS, and determining a supportable operation mode on the basis of the supportable operation mode of the MS.

According to a further aspect of the present disclosure, an apparatus for managing an operation mode of an MS that uses a service of a strict interactive response time in a BS of a wireless communication system is provided. The apparatus includes an operation mode manager and a transmitter. The operation mode manager determines a supportable operation mode of the MS considering at least one of a service type of the MS, an interactive response time required condition of the service, and a user profile of the MS. The transmitter sends the MS a control message including the supportable operation mode of the MS.

According to a yet another aspect of the present disclosure, an apparatus for controlling an operation mode in an MS of a wireless communication system is provided. The apparatus includes a receiver and a controller. The receiver receives a control message from a BS. The controller determines the MS supportable operation mode based on a supportable operation mode of the MS determined considering at least one of a service type of the MS, an interactive response time required condition of a service, and a user profile of the MS in the control message provided from the BS through the receiver.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a procedure for performing paging to a Mobile Station (MS) that is in an idle state according to the conventional art;

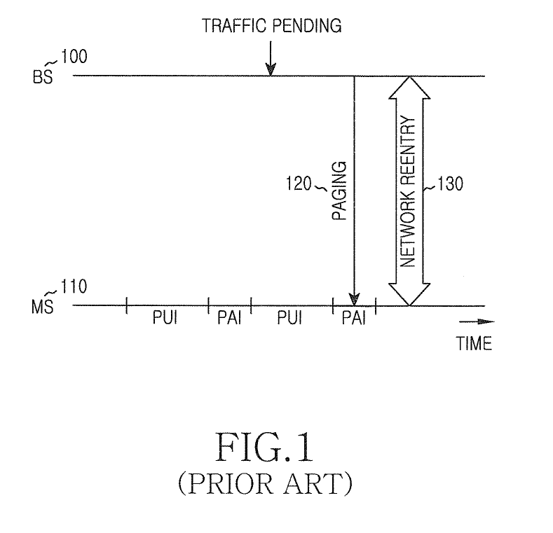

FIG. 2 is a ladder diagram illustrating a procedure for restricting an operation mode of an MS using a Dynamic Service Addition (DSA) message in a wireless communication system according to the present disclosure;

FIG. 3 illustrates a process for restricting an operation mode of an MS using a DSA message in a Base Station (BS) according to the present disclosure;

FIG. 4 illustrates a process for determining operation mode information through a DSA message in an MS according to the present disclosure;

FIG. 5 is a ladder diagram illustrating a procedure for restricting an operation mode of an MS using a registration message in a wireless communication system according to the present disclosure;

FIG. 6 illustrates a process for restricting an operation mode of an MS using a registration message in a BS according to the present disclosure;

FIG. 7 illustrates a process for determining operation mode information through a registration message in an MS according to the present disclosure;

FIG. 8 is a block diagram illustrating a construction of a BS according to the present disclosure; and

FIG. 9 is a block diagram illustrating a construction of an MS according to the present disclosure.

### DETAILED DESCRIPTION OF THE INVENTION

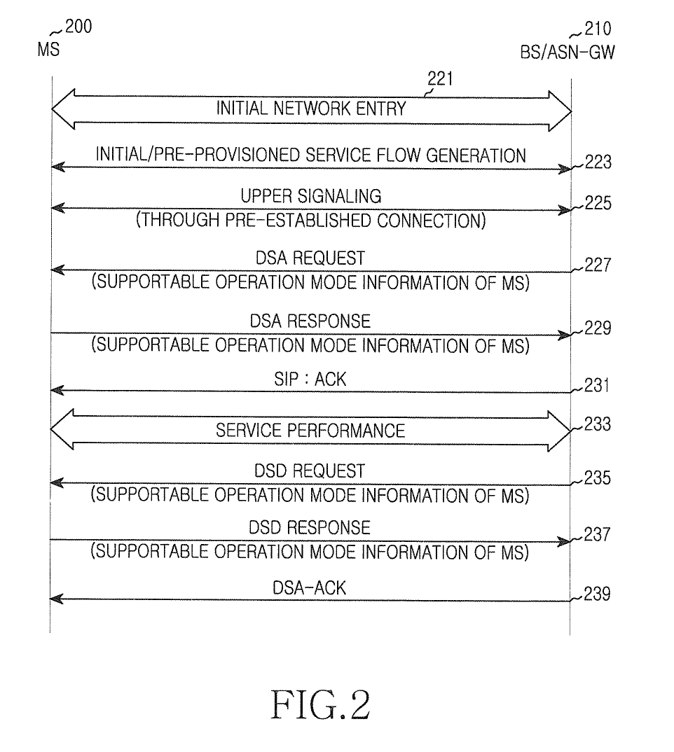

FIGS. 2 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system. Embodiments of the present invention will be described herein below with reference to the accompanying drawings. In the following description, well-known functions or constructions are not described in detail since they would obscure the invention in unnecessary detail. Terms described below, which are defined considering functions in the present invention, can be different depending on user and operator's intention or practice. Therefore, the terms should be defined based on the disclosure throughout this specification. Preferred embodiments of the present invention will be described herein below with reference to the accompanying drawings. In the following description, well-known functions or constructions are not described in detail since they would obscure the invention in unnecessary detail. And, terms described below, which are defined considering functions in the present invention, can be different depending on user and operator's intention or practice. Therefore, the terms should be defined based on the disclosure throughout this specification.

Below, exemplary embodiments of the present disclosure provide technology for restricting an operation mode of a Mobile Station (MS) in a wireless communication system.

Below, exemplary embodiments of the present disclosure provide technology for restricting an operation mode of an MS according to an interactive response time of a service having a strict interactive response time required condition in a wireless communication system.

The following description is made, for example, for a wireless communication system defined in the Institute of Electrical and Electronics Engineers (IEEE) 802.16m standard. However, the present disclosure is also applicable to wireless communication systems defined in other standards.

As illustrated in FIG. 2 below, a Base Station (BS) and an MS of the wireless communication system can negotiate an operation mode of the MS through a Dynamic Service Addition/Change/Deletion (DSx) procedure. Here, the DSx procedure includes a process in which the BS and the MS exchange a DSx message with each other for service addition/change/deletion.

FIG. 2 illustrates a procedure for restricting an operation mode of an MS using a Dynamic Service Addition (DSA) message in a wireless communication system according to the present disclosure. In the following description, a BS 210 represents an Access Service Network (ASN) that includes a BS and an Access Service Network-GateWay (ASN-GW).

As illustrated in FIG. 2, an MS 200 performs initial network entry through a BS 210 (step 221).

After the initial network entry of the MS 200 is completed, the MS 200 and BS 210 generate a service flow (step 223). For example, the MS 200 and BS 210 generate an initial/pre-provisioned service flow.

The MS 200 performs upper signaling with an upper network entity through the generated service flow (step 225). For example, the MS 200 initiates an application program for upper signaling and performs the upper signaling with the upper network entity through the BS 210. Here, the upper network entity includes an application server, and the upper signaling includes Session Initialization Protocol (SIP) protocol signaling.

The BS 210 determines a service type of the MS 200 and an interactive response time required condition of a service using an upper signaling message provided from the upper network entity. For example, the BS 210 determines an operation mode supportable by the MS 200 in consideration of the service type of the MS 200 and the interactive response time required condition of the service.

After that, the BS 210 generates a DSA request message to establish a connection for application data transmission/reception. Here, the DSA request message includes operation mode information supportable by the MS 200 in a form of Table 1 below.

TABLE 1

| | Attributes/Array | Size | | |
|---|---|---|---|---|
| M/O | of attributes | (bits) | Value/Note | Conditions |
| 0 | AMS Operation | 2 | Bit 0: Sleep mode support | |
| | Mode Supported | | Bit 1: Idle mode support | |
| | | | A bit value of 0 indicates | |
| | | | “not supported” while 1 | |
| | | | indicates “supported.” | |

In Table 1 above, in an example where the BS 210 restricts idle state transition of the MS 200, the supportable operation mode information of the MS 200 is set to “0b10”. In contrast, in an example where the BS 210 restricts sleep mode transition of the MS 200 and permits the idle state transition of the MS 200, the supportable operation mode information of the MS 200 is set to “0b01”.

The BS 210 sends the MS 200 the DSA request message including the operation mode information supportable by the MS 200 (step 227).

The MS 200 determines the supportable operation mode information of the MS 200 included in the DSA request message. At this time, the MS 200 determines an operation mode that the MS 200 will support itself based on the supportable operation mode information of the MS 200 included in the DSA request message. For another example, the MS 200 may determine whether to accept the supportable operation mode information of the MS 200 included in the DSA request message.

After that, the MS 200 sends the BS 210 a DSA response message including the MS's 200 supportable operation mode information (step 229). For example, the MS 200 transmits the MS's 200 determining operation mode information to the BS 210 using the DSA response message, based on the supportable operation mode information of the MS 200 included in the DSA request message. For another example, the MS 200 may transmit an acceptance or non-acceptance of the supportable operation mode information of the MS 200 included in the DSA request message to the BS 210, using the DSA response message.

If the DSA response message is received, the BS 210 sets a packet classification rule, and sends a DSA ACKnowledgement (ACK) message to the MS 200 (step 231).

Next, the MS 200 and BS 210 perform a service (step 233). At this time, the MS 200 can perform a state transition within a supportable operation mode determined through a negotiation with the BS 210.

In an example where the MS 200 or the BS 210 makes a request for application service termination in course of the service performance, the MS 200 and BS 210 determine whether to terminate the service performance between the MS 200 and the BS 210 through the upper signaling with the upper network entity.

In an example where the MS 200 and BS 210 determine to terminate the service performance, the BS 210 determines an operation mode that is supportable by the MS 200 after service termination.

After that, the BS 210 sends the MS 200 a DSD request message including operation mode information that is supportable by the MS 200 after service termination (step 235).

The MS 200 determines, in the DSD request message, the operation mode information that is supportable by the MS 200 after the service termination. At this time, the MS 200 determines an operation mode that the MS 200 will support the MS 200 based on the operation mode information supportable by the MS 200 after the service termination included in the DSD request message. For another example, the MS 200 may determine whether to accept the operation mode information supportable by the MS 200 after the service termination included in the DSD request message.

Next, the MS 200 sends the BS 210 a DSD response message including the MS's 200 supportable operation mode information (step 237). For example, the MS 200 transmits the MS's 200 determining operation mode information to the BS 210 using the DSD response message, based on the supportable operation mode information of the MS 200 included in the DSD request message. For another example, the MS 200 may transmit an acceptance or non-acceptance of the supportable operation mode information of the MS 200 included in the DSD request message to the BS 210, using the DSD response message.

The BS 210 sends the MS 200 a DSD ACK message in response to the DSD response message (step 239).

In an example where the DSD ACK message is received, the MS 200 can perform a state transition within the supportable operation mode determined through the negotiation with the BS 210.

As described above, an MS 200 and a BS 210 negotiate a supportable operation mode using a DSx message. At this time, in an example where the MS 200 provides a Push To Talk (PTT) service, the MS 200 and BS 210 generate or release a service flow for the PTT service through a DSx procedure. At this time, when the MS 200 and BS 210 generate and release the service flow for the PTT service, the MS 200 and BS 210 can negotiate an operation mode supportable by the MS 200. Here, the PTT service includes a service for emergency.

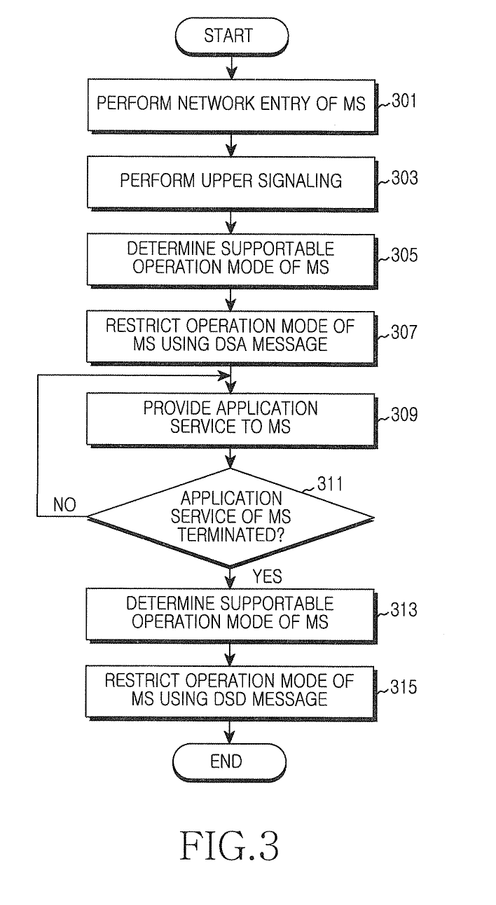

FIG. 3 illustrates a procedure for restricting an operation mode of an MS using a DSA message in a BS according to the present disclosure. In the following description, it is assumed to provide a PTT service to the MS. However, it is identically applicable even to an example of providing other service sensitive to a delay to the MS.

Referring to FIG. 3, in step 301, the BS performs an initial network entry procedure of an MS. For example, the BS performs a ranging procedure, an authentication procedure, a registration procedure, and a capability negotiation procedure with the MS to complete the initial network entry procedure of the MS.

After initial network entry of the MS, the BS proceeds to step 303 and transmits/receives a signal for upper signaling between the MS and an upper network entity. For example, the BS generates a service flow with the MS after the initial network entry of the MS. And then, the BS controls such that the MS and the upper network entity perform the upper signaling through the generated service flow.

Next, the BS proceeds to step 305 and determines a supportable operation mode of the MS using an upper signaling message provided from the upper network entity. For example, the BS determines whether to generate a new service flow/connection with the MS and, if determining to generate the new service flow/connection with the MS, the BS determines an operation mode supportable by the MS considering a service type of the MS or an interactive response time required condition of a service. Here, the service type or the interactive response time required condition is determined using the upper signaling message. In an example where a service newly established with the MS is a service sensitive to an interactive response delay of the MS such as a PTT service, the BS does not permit an idle state transition of the MS. On the other hand, in an example where the BS manages the idle state transition of the MS for the purpose of PTT service capability increment, the BS may restrict a sleep mode transition of the MS, and permit the idle state transition of the MS.

After determining the supportable operation mode of the MS, the BS proceeds to step 307 and restricts the supportable operation mode of the MS using a DSA message. For instance, the BS sends the MS a DSA request message including the supportable operation mode information of the MS determined in step 305. And then, the BS recognizes supportable operation mode information of the MS included in a DSA response message provided from the MS as the supportable operation mode of the MS while a service flow/connection newly generated through the DSA procedure is kept.

After restricting the supportable operation mode of the MS, the BS proceeds to step 309 and provides an application service to the MS through the service flow/connection generated through the DSA procedure. Here, the application service includes application services sensitive to a delay of an interactive response time of an MS such as a PTT service.

Next, the BS proceeds to step 311 and determines whether to terminate the application service with the MS. For example, in an example where the MS or the BS makes a request for application service termination in course of application service provision, the MS and BS determine whether to terminate application service performance through upper signaling with the upper network entity.

In an example where the MS and BS determine not to terminate the application service, the BS returns to step 309 and provides the application service to the MS.

On the other hand, in an example where the MS and BS determine to terminate the application service, the BS proceeds to step 313 and determines an operation mode supportable by the MS after application service termination.

After determining the operation mode supportable by the MS after the application service termination, the BS proceeds to step 315 and restricts the supportable operation mode of the MS using a DSD message. For instance, the BS sends the MS a DSD request message including the supportable operation mode information of the MS determined in step 313. And then, the BS recognizes supportable operation mode information of the MS included in a DSD response message provided from the MS as the operation mode supportable by the MS after the application service termination.

After that, the BS terminates the algorithm according to the present disclosure.

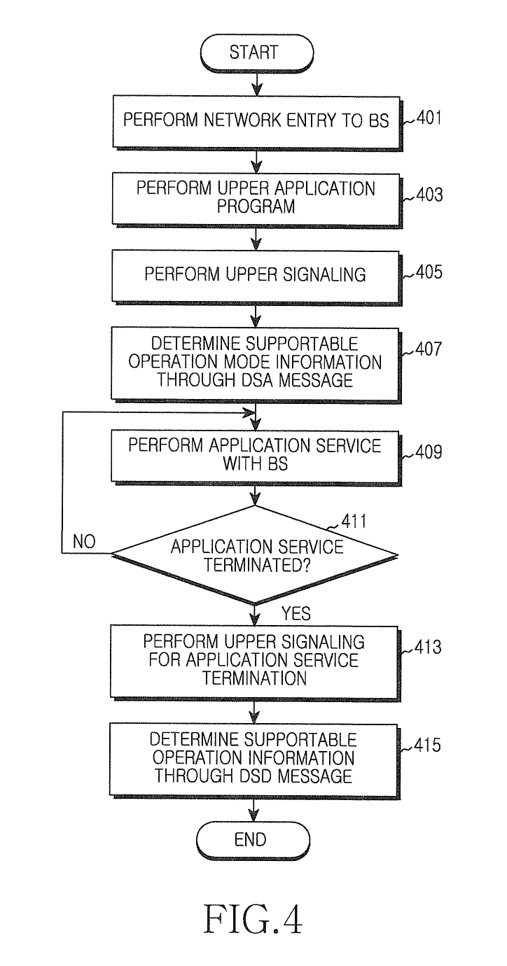

FIG. 4 illustrates a procedure for determining operation mode information through a DSA message in an MS according to the present disclosure.

Referring to FIG. 4, in step 401, the MS performs an initial network entry procedure through a BS. For example, the MS performs a ranging procedure, an authentication procedure, a registration procedure, and a capability negotiation procedure with the BS to complete the initial network entry procedure.

After that, the MS proceeds to step 403 and initiates an application program for upper signaling. For instance, after completing the initial network entry, the MS generates a service flow with the BS. And then, the MS initiates the application program for the upper signaling.

After initiating the application program, the MS proceeds to step 405 and performs upper signaling with an upper network entity through the BS. Here, the upper network entity includes an application server, and the upper signaling includes SIP protocol signaling.

Next, the MS proceeds to step 407 and determines supportable operation mode information through a DSA message for generating a new service flow/connection with the BS. For example, the MS determines the MS's supportable operation mode information included in a DSA request message provided from the BS. And then, the MS determines the MS's own supportable operation mode based on the MS's supportable operation mode information included in the DSA request message. At this time, the MS transmits the MS's determining supportable operation mode information to the BS through a DSA response message. For another example, the MS may recognize the MS's supportable operation mode information included in the DSA request message as the MS's supportable operation mode information.

After determining the supportable operation mode information, the MS proceeds to step 409 and receives an application service from the BS through the service flow/connection generated through the DSA procedure. At this time, the MS can perform a state transition within the supportable operation mode determined in step 407.

Next, the MS proceeds to step 411 and determines whether to terminate the application service with the BS. For example, the MS or the BS makes a request for application service termination in course of application service provision; the MS and BS determine whether to terminate application service performance through upper signaling with the upper network entity.

In an example where the MS and BS determine not to terminate the application service in step 411, the MS returns to step 409 and receives the application service from the BS.

In contrast, in an example where the MS and BS determine to terminate the application service in step 411, the MS proceeds to step 413 and performs upper signaling for the application service termination with the upper network entity through the BS.

After that, the MS proceeds to step 415 and determines an operation mode supportable after application service termination. For example, the MS determines the MS's supportable operation mode information included in a DSD request message provided from the BS. And then, the MS determines the MS's supportable operation mode based on the MS's supportable operation mode information included in the DSD request message. At this time, the MS transmits the MS's determining supportable operation mode information to the BS through a DSD response message. For another example, the MS may recognize the MS's supportable operation mode information included in the DSD request message as the MS's supportable operation mode information.

Next, the MS terminates the algorithm according to the present disclosure.

In the aforementioned example, an MS and a BS restrict a supportable operation mode of the MS through a DSx procedure.

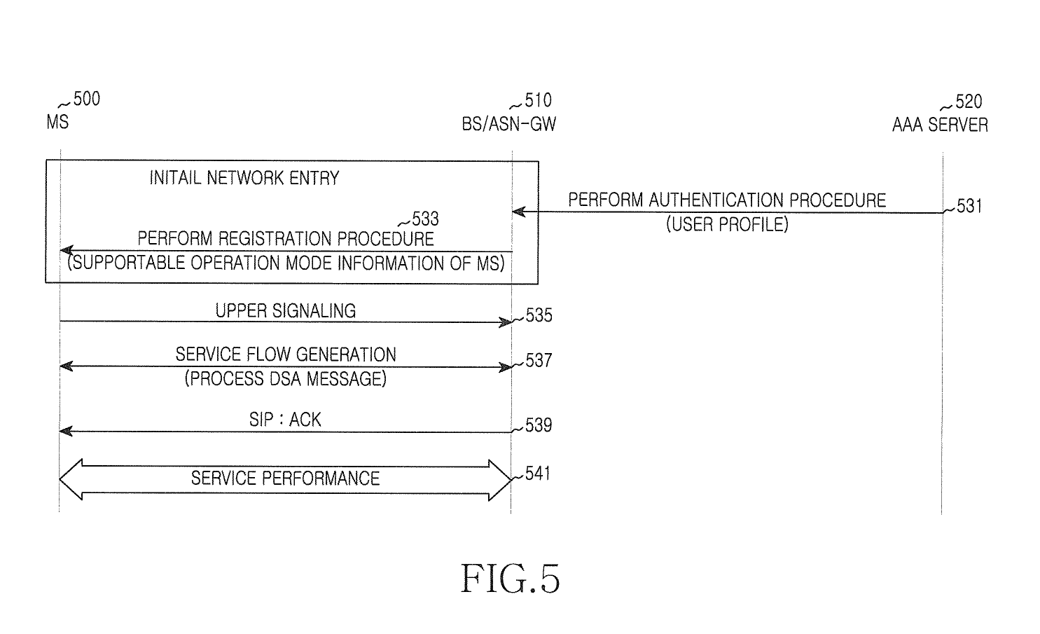

In another example, an MS and a BS may restrict a supportable operation mode of the MS in an initial network entry process of the MS. At this time, the MS and BS may restrict the supportable operation mode of the MS through a registration procedure as illustrated in FIG. 5 below.

FIG. 5 illustrates a procedure for restricting an operation mode of an MS using a registration message in a wireless communication system according to the present disclosure. In the following description, a BS 510 represents an ASN that includes a BS and an ASN-GW.

As illustrated in FIG. 5, an MS 500 performs initial network entry through a BS 510. For example, the MS 500 and the BS 510 perform a ranging procedure, an authentication procedure, a registration procedure, and a capability negotiation procedure for the sake of network entry of the MS 500. The BS 510 acquires a user profile for the MS 500 from an Authentication, Authorization and Accounting (AAA) server 520 through the authentication procedure (step 531). Here, the user profile includes a user identity, user's service subscription information, user state information and the like.

Next, the MS 500 and the BS 510 negotiate a supportable operation mode of the MS 500 through the registration procedure (step 533). For instance, the MS 500 sends a registration request message to the BS 510. The BS 510 determines the supportable operation mode of the MS 500 considering the user profile. And then, the BS 510 sends the MS 500 a registration response message including the MS's determining supportable operation mode information of the MS 500.

For another example, the MS 500 sends the BS 510 a registration request message including the MS's determining supportable operation mode information. The BS 510 determines a supportable operation mode of the MS 500 considering the supportable operation mode of the MS 500 determined in the registration request message and the user profile. And then, the BS 510 sends the MS 500 a registration response message including the MS's determining supportable operation mode information of the MS 500.

If a network entry procedure with the BS 510 is completed, the MS 500 performs upper signaling through the BS 510 (step 535). For example, after the initial network entry of the MS 500 is completed, the MS 500 and BS 510 generate an initial/pre-provisioned service flow, and initiate an application program for upper signaling. And then, the MS 500 performs upper signaling such as SIP protocol signaling, with an upper network entity such as an application server through the BS 510.

In an example where the BS 510 determines to generate a new service flow/connection with the MS 500, the BS 510 performs a DSA procedure with the MS 500 (step 537). For example, the BS 510 sends a DSA request message to the MS 500. In response to the DSA request message, the MS 500 sends a DSA response message to the BS 510. In response to the DSA response message, the BS 510 sends the MS 500 a DSA ACK message to generate a new service flow/connection.

After generating the new service flow/connection through the DSA procedure, the BS 510 sends an ACK message for upper signaling to the MS 500 (step 539).

Next, the MS 500 and BS 510 perform a service (step 541). At this time, the MS 500 can perform a state transition within the supportable operation mode determined through the negotiation with the BS 510.

As described above, an MS 500 and a BS 510 negotiate a supportable operation mode of the MS 500 using a registration request/response message. At this time, the registration request/response message includes supportable operation mode information of the MS 500 in a form of Table 1 above.

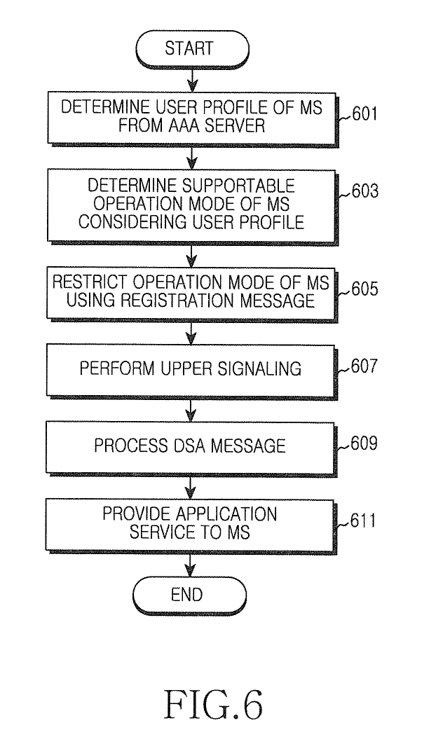

FIG. 6 illustrates a procedure for restricting an operation mode of an MS using a registration message in a BS according to the present disclosure. In the following description, it is assumed that a supportable operation mode of the MS is determined in the BS.

Referring to FIG. 6, in step 601, the BS performs an authentication procedure of an MS. At this time, the BS acquires a user profile for the MS from an AAA server through the authentication procedure of the MS. Here, the user profile includes a user identity, user's service subscription information, user state information and the like.

After that, the BS proceeds to step 603 and determines a supportable operation mode of the MS according to a service type of the MS or a service required condition of the MS, which is included in the user profile. For example, in an example where a service newly established with the MS is a service sensitive to an interactive response delay of the MS such as a PTT service, the BS does not permit an idle state transition of the MS. For another example, in an example where the BS manages the idle state transition of the MS for the purpose of P a service capability increment, the BS may restrict a sleep mode transition of the MS, and permit the idle state transition of the MS.

After determining the supportable operation mode of the MS in step 603, the BS proceeds to step 605 and restricts the supportable operation mode of the MS using a registration message. For example, after the authentication procedure is completed, the MS sends the BS a registration request message. The BS sends the MS a registration response message including the supportable operation mode information of the MS determined in step 603. At this time, the registration response message includes the supportable operation mode information of the MS in a form of Table 1 above.

After restricting the supportable operation mode of the MS in step 605, the BS proceeds to step 607 and transmits/receives a signal for upper signaling between the MS and an upper network entity. For example, after initial network entry of the MS, the BS generates an initial/pre-provisioned service flow with the MS. And then, the BS controls such that the MS and the upper network entity perform upper signaling through the generated service flow.

Next, the BS proceeds to step 609 and performs a DSA procedure with the MS to generate a new service flow/connection. For instance, the BS determines whether to generate a new service flow/connection with the MS and, if determining to generate the new service flow/connection with the MS, the BS generates a new service flow/connection through the DSA procedure with the MS.

After generating the new service flow/connection in step 609, the BS proceeds to step 611 and provides an application service to the MS through the service flow/connection generated through the DSA procedure.

After that, the BS terminates the algorithm according to the present disclosure.

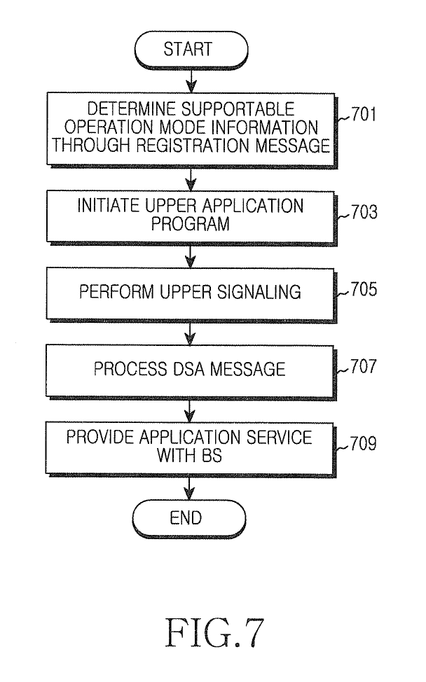

FIG. 7 illustrates a procedure for determining operation mode information through a registration message in an MS according to the present disclosure. In the following description, it is assumed that a supportable operation mode of the MS is determined in a BS.

Referring to FIG. 7, in step 701, the MS determines operation mode information through a registration message. For example, after performing an authentication procedure with a BS for initial network entry, the MS sends a registration request message to the BS. And then, the MS determines supportable operation mode information in a registration response message provided from the BS.

After that, the MS proceeds to step 703 and initiates an application program for upper signaling. For example, after the initial network entry is completed, the MS generates an initial/pre-provisioned service flow with the BS. And then, the MS initiates the application program for upper signaling.

After initiating the application program, the MS proceeds to step 705 and performs upper signaling with an upper network entity through the BS. Here, the upper network entity includes an application server, and the upper signaling includes SIP protocol signaling.

Next, the MS proceeds to step 707 and performs a DSA procedure for the sake of generation of a new service flow/connection with the BS.

After generating the new service flow/connection through the DSA procedure, the MS proceeds to step 709 and receives an application service from the BS through the service flow/connection generated through the DSA procedure. At this time, the MS can perform a state transition within the supportable operation mode determined in step 701.

Next, the MS terminates the algorithm according to the present disclosure.

In the aforementioned example, after performing an authentication procedure with a BS, an MS sends a registration request message to the BS. In response to the registration request message, the BS sends the MS a registration response message including supportable operation mode information of the MS determined using a user profile of the MS.

In another example, an MS sends the BS a registration request message including the MS's determining supportable operation mode information. In this example, the BS determines a supportable operation mode of the MS considering the supportable operation mode of the MS determined in the registration request message and the user profile. And then, the BS sends the MS a registration response message including the MS's determining supportable operation mode information of the MS.

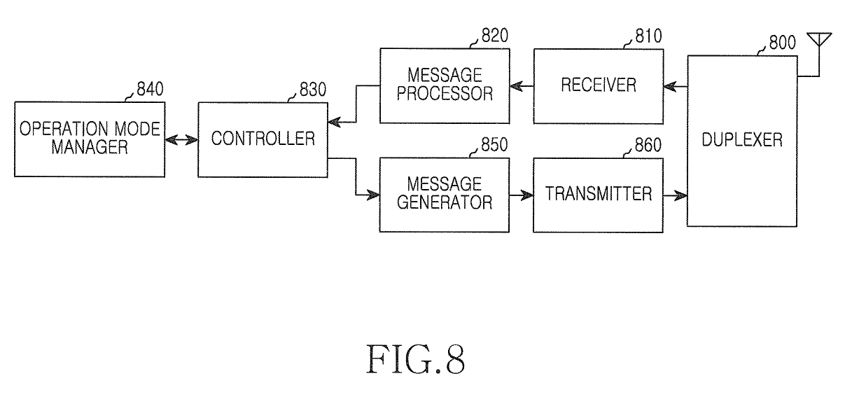

FIG. 8 illustrates a construction of a BS according to the present disclosure.

As illustrated in FIG. 8, the BS includes a duplexer 800, a receiver 810, a message processor 820, a controller 830, an operation mode manager 840, a message generator 850, and a transmitter 860.

The duplexer 800 transmits a transmit signal provided from the transmitter 860 through an antenna according to a duplexing scheme, and provides a receive signal from the antenna to the receiver 810.

The receiver 810 converts a Radio Frequency (RF) signal provided from the duplexer 800 into a baseband signal for demodulation. The receiver 810 can include an RF processing block, a demodulation block, a channel decoding block and the like. For example, the RF processing block converts an RF signal provided from the duplexer 800 into a baseband signal. The demodulation block is composed of a Fast Fourier Transform (FFT) operator for extracting data loaded on each subcarrier from a signal provided from the RF processing block and the like. The channel decoding block is composed of a demodulator, a de-interleaver, a channel decoder and the like.

The message processor 820 extracts a control message from a receive signal provided from the receiver 810 and transmits the control message to the controller 830. For instance, the message processor 820 extracts a DSA response message or a DSD response message from the receive signal and transmits the extracted message to the controller 830. For another instance, the message processor 820 extracts a registration request message from the receive signal and sends the extracted message to the controller 830.

The controller 830 controls a general operation of the BS.

The controller 830 restricts an operation mode of the MS using supportable operation mode information of an MS determined in the operation mode manager 840. For example, as illustrated in FIG. 3, the controller 830 controls to transmit the supportable operation mode information of the MS determined in the operation mode manager 840 to the MS through a DSx request message. For another example, as illustrated in FIG. 6, the controller 830 controls to transmit the supportable operation mode information of the MS determined in the operation mode manager 840 to the MS through a registration response message.

The operation mode manager 840 determines a supportable operation mode of an MS. For example, in an example where a service newly established with the MS is sensitive to an interactive response delay of the MS such as a PTT service, the operation mode manager 840 does not permit an idle state transition of the MS. For another example, in an example where the BS manages the idle state transition of the MS for the purpose of PTT service capability increment, the operation mode manager 840 may restrict a sleep mode transition of the MS, and permit the idle state transition of the MS.

The message generator 850 generates a control message to be sent to an MS according to the control of the controller 830. For instance, the message generator 850 generates a DSx request message including supportable operation mode information of an MS determined in the operation mode manager 840 according to the control of the controller 830. For another instance, the message generator 850 generates a registration response message including supportable operation mode information of an MS determined in the operation mode manager 840 according to the control of the controller 830.

The transmitter 860 encodes data and control message to be transmitted to an MS, converts the data and control message into an RF signal, and transmits the RF signal to the duplexer 800. For instance, the transmitter 860 can include a channel coding block, a modulation block, an RF processing block and the like. Here, the channel coding block is composed of a modulator, an interleaver, a channel encoder and the like. The modulation block is composed of an Inverse Fast Fourier Transform (IFFT) operator for mapping a signal provided from the channel coding block to each subcarrier and the like. The RF processing block converts a baseband signal provided from the modulation block into an RF signal and outputs the RF signal to the duplexer 800.

In the aforementioned construction, the controller 830, a protocol controller, can perform a function of the operation mode manager 840. These are separately constructed in order to distinguish and describe respective functions in the present disclosure. Thus, in an actual realization, construction can be such that all or some of the functions are processed in the controller 830.

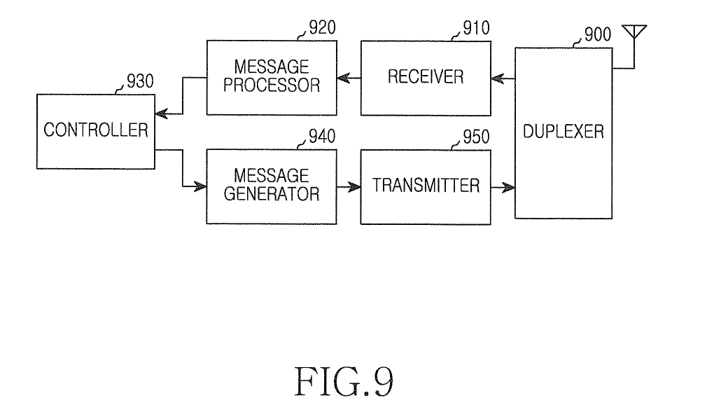

FIG. 9 illustrates a construction of an MS according to the present disclosure.

As illustrated in FIG. 9, the BS includes a duplexer 900, a receiver 910, a message processor 920, a controller 930, a message generator 940, and a transmitter 950.

The duplexer 900 transmits a transmit signal provided from the transmitter 950 through an antenna according to a duplexing scheme, and provides a receive signal from the antenna to the receiver 910.

The receiver 910 converts a Radio Frequency (RF) signal provided from the duplexer 900 into a baseband signal for demodulation. The receiver 910 can include an RF processing block, a demodulation block, a channel decoding block and the like. For example, the RF processing block converts an RF signal provided from the duplexer 900 into a baseband signal. The demodulation block is composed of a Fast Fourier Transform (FFT) operator for extracting data loaded on each subcarrier from a signal provided from the RF processing block and the like. The channel decoding block is composed of a demodulator, a de-interleaver, a channel decoder and the like.

The message processor 920 extracts a control message from a receive signal provided from the receiver 910 and transmits the control message to the controller 930. For instance, the message processor 920 extracts a DSA request message or a DSD request message from the receive signal and transmits the extracted message to the controller 930. For another instance, the message processor 920 extracts a registration response message from the receive signal and sends the extracted message to the controller 930.

The controller 930 controls a general operation of the MS. For example, as illustrated in FIG. 4, the controller 930 determines the MS's supportable operation mode information according to supportable operation mode information included in a DSx request message provided from the BS. For another example, as illustrated in FIG. 7, the controller 930 determines the MS's supportable operation mode information according to supportable operation mode information included in a registration response message provided from the BS.

The message generator 940 generates a control message to be sent to a BS according to the control of the controller 930. For instance, the message generator 940 generates a DSx response message including the MS's determining supportable operation mode information according to the control of the controller 930. For another instance, the message generator 940 generates a registration request message including the MS's determining supportable operation mode information according to the control of the controller 930.

The transmitter 950 encodes data and control message to be transmitted to a BS, converts the data and control message into an RF signal, and transmits the RF signal to the duplexer 900. For instance, the transmitter 950 can include a channel coding block, a modulation block, an RF processing block and the like. Here, the channel coding block is composed of a modulator, an interleaver, a channel encoder and the like. The modulation block is composed of an IFFT operator for mapping a signal provided from the channel coding block to each subcarrier and the like. The RF processing block converts a baseband signal provided from the modulation block into an RF signal and outputs the RF signal to the duplexer 900.

As described above, exemplary embodiments of the present disclosure have an advantage of, by restricting an operation mode to which an MS can make a transition through a negotiation between a BS and the MS, being capable of reducing a delay of an operation mode transition of the MS and smoothly providing an emergency service requiring a strict interactive response time in a wireless communication system.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A method for managing an operation mode of a Mobile Station (MS) that uses a service of a strict interactive response time in a Base Station (BS) of a wireless communication system, the method comprising:
determining a supportable operation mode of the MS considering at least one of a service type of the MS, an interactive response time required condition of the service, and a user profile of the MS; and
sending the MS a control message comprising the supportable operation mode of the MS.

2. The method of claim 1, wherein the operation mode of the MS comprises at least one of a sleep mode and an idle mode.

3. The method of claim 1, wherein the control message comprises at least one of a dynamic service control message and a registration response message, and
wherein the dynamic service control message comprises at least one of a dynamic service addition request message and a dynamic service deletion request message.

4. The method of claim 3, wherein sending the MS the control message comprises:
responsive to the control message being the registration response message, determining whether a registration request message is received from the MS; and
responsive to receiving the registration request message from the MS, sending the MS the registration response message comprising the supportable operation mode of the MS.

5. The method of claim 1, wherein the user profile of the MS is acquired through an authentication procedure with the MS attempting network entry, and
wherein the user profile of the MS comprises at least one of a user identity of the MS, user's service subscription information, and user state information.

6. The method of claim 1, wherein determining the supportable operation mode of the MS comprises:
responsive to identifying that the MS uses the service of the strict interactive response time, restricting an idle state transition of the MS; and
responsive to aiming at a service capacity increment of the service of the strict interactive response time, restricting a sleep mode transition of the MS.

7. A method for controlling an operation mode in a Mobile Station (MS) of a wireless communication system, the method comprising:
receiving a control message from a Base Station (BS) including a supportable operation mode of the MS determined from considering at least one of a service type of the MS, an interactive response time required condition of a service, and a user profile of the MS; and
determining, by the MS, the supportable operation mode based on the supportable operation mode from the control message.

8. The method of claim 7, wherein the operation mode of the MS comprises at least one of a sleep mode and an idle mode.

9. The method of claim 7, wherein the control message comprises at least one of a dynamic service control message and a registration response message, and
wherein the dynamic service control message comprises at least one of a dynamic service addition request message and a dynamic service deletion request message.

10. The method of claim 7, wherein the supportable operation mode of the MS comprises information restricting an idle state transition of the MS when the MS uses a service of a strict interactive response time, and the supportable operation mode of the MS comprises information restricting a sleep mode transition of the MS when aiming at a service capacity increment of the service of the strict interactive response time.

11. An apparatus for managing an operation mode of a Mobile Station (MS) that uses a service of a strict interactive response time in a Base Station (BS) of a wireless communication system, the apparatus comprising:
an operation mode manager configured to determine a supportable operation mode of the MS considering at least one of a service type of the MS, an interactive response time required condition of the service, and a user profile of the MS; and
a transmitter configured to send the MS a control message comprising the supportable operation mode of the MS.

12. The apparatus of claim 11, wherein the operation mode of the MS comprises at least one of a sleep mode and an idle mode.

13. The apparatus of claim 11, wherein the transmitter is further configured to include a supportable operation mode of the MS in at least one control message of a dynamic service control message and a registration response message, and send the one control message comprising the supportable operation mode of the MS, to the MS, and
wherein the dynamic service control message comprises at least one of a dynamic service addition request message and a dynamic service deletion request message.

14. The apparatus of claim 13, wherein in sending the control message, the transmitter is further configured to send a registration response message comprising the supportable operation mode of the MS to the MS in response to the control message being the registration response message and in a response to receiving the registration response message from the MS.

15. The apparatus of claim 11, wherein the user profile of the MS is acquired through an authentication procedure with the MS attempting network entry, and
wherein the user profile of the MS comprises at least one of a user identity of the MS, user's service subscription information, and user state information.

16. The apparatus of claim 11, wherein, in a case where the MS uses the service of the strict interactive response time, the operation mode manager is further configured to restrict an idle state transition of the MS and, in a case of aiming at a service capacity increment of the service of the strict interactive response time, restrict a sleep mode transition of the MS.

17. An apparatus for controlling an operation mode in a Mobile Station (MS) of a wireless communication system, the apparatus comprising:
a receiver configured to receive a control message from a Base Station (BS); and
a controller configured to determine a supportable operation mode of the MS based on a supportable operation mode in the control message determined from considering at least one of a service type of the MS, an interactive response time required condition of a service, and a user profile of the MS.

18. The apparatus of claim 17, wherein the operation mode of the MS comprises at least one of a sleep mode and an idle mode.

19. The apparatus of claim 17, wherein the control message comprises at least one of a dynamic service control message and a registration response message, and
wherein the dynamic service control message comprises at least one of a dynamic service addition request message and a dynamic service deletion request message.

20. The apparatus of claim 17, wherein, when the MS uses a service of a strict interactive response time, the supportable operation mode of the MS comprises information restricting an idle state transition of the MS and, when aiming at a service capacity increment of the service of the strict interactive response time, the supportable operation mode of the MS comprises information restricting a sleep mode transition of the MS.
